(19) United States
(12) Patent Application Publication
(10) Pub. No.: US 2021/0024783 A1
(43) Pub. Date: Jan. 28, 2021

(54) Adhesive tape for applying to a component of a motor vehicle, use of an adhesive tape, assembly of two components, and method for sticking together two components of a motor vehicle

(71) Applicant: Webasto SE, Stockdorf (DE)

(72) Inventor: Christian STEINBACHER, Stockdorf (DE)

(21) Appl. No.: 16/641,061

(22) PCT Filed: Jul. 31, 2018
(86) PCT No.: PCT/EP2018/070734

§ 371 Date: Feb. 21, 2020

(30) Foreign Application Priority Data
Sep. 27, 2017 (DE) 10 2017 122 431.9

(51) Int. Cl. C09J 7/50; C09J 7/38; C09J 7/35; C09J 5/04; C09J 5/02; C09J 175/04

(52) U.S. Cl. CPC C09J 7/50; C09J 7/38; C09J 7/35; C09J 5/04; C09J 5/02; C09J 175/04; C09J 2301/416; C09J 2301/302; C09J 2400/143; C09J 2400/163; C09J 2400/123; C09J 2475/008; C09J 2301/124

(57) ABSTRACT

An adhesive tape for application to a component of a motor vehicle, consisting of a primer layer having a self-adhesive lower side and a self-adhesive upper side, where the primer layer is embodied such that it is activatable for chemical reaction with an adhesive. The use of an adhesive tape, to an assembly, and to a method is also provided.

Adhesive tape for applying to a component of a motor vehicle, use of an adhesive tape, assembly of two components, and method for sticking together two components of a motor vehicle

The invention relates to an adhesive tape for application to a component of a motor vehicle. The invention further relates to the use of such an adhesive tape for bonding two components of a motor vehicle, to the assembly of two components of a motor vehicle, and to a method for bonding two components of a motor vehicle.

For the bonding of two components in the motor vehicle sector, as for example for joining a transparent roof element to a frame element in the vehicle roof, the practice is to use not only the adhesive itself but what are called primers (or adhesion promoters), to ensure a secure connection between the respective components. The primers are applied typically by hand as liquid materials. A pretreatment of this kind for adhesive bonding, also referred to as surface treatment, is typically required when components with an inorganic surface are to be bonded to components with an organic surface.

U.S. Pat. No. 4,885,887 A discloses an EPDM insulating tape having an additional primer coating.

An object underlying the invention is to specify an approach which contributes to particularly efficient bonding of two components in the motor vehicle sector.

According to one aspect an adhesive tape for application to a component of a motor vehicle is disclosed. The adhesive tape consists of a primer layer having a self-adhesive lower side and a self-adhesive upper side. The primer layer is embodied such as to be activatable for chemical reaction with an adhesive.

The adhesive tape described, which may also be referred to as primer tape or adhesive primer tape, consists according to at least one embodiment of the primer or primer material, which may be applied as a self-adhesive layer to a component of a motor vehicle and which attaches to it. In other words, a primer solely as a tape can be applied itself directly to a component. To put it another way, the primer is embodied as an adhesive tape and has no further, additional layers, such as polyethylene layers, for instance. The adhesive tape therefore comprises exclusively an activatable primer material. The primer is not applied wet-chemically or as an additional layer of an adhesive tape. By means of the adhesive tape, therefore, the aforementioned surface pretreatment for adhesive bonding to a further component can be accomplished efficiently and cost-effectively.

The adhesive tape advantageously enables precise application of the primer, in relation for instance to a layer thickness and a defined track on the component. In particular in comparison to wet-chemical application, which typically is carried out manually, a defined primer pretreatment is ensured. For example, through a defined layer thickness of the primer tape, which may amount, for example, to 5 to 20 μm, homogeneous distribution on the component is ensured. Moreover, the adhesive tape is a contributor to the enablement of automated application of the adhesive tape and hence of the primer. For example, the adhesive tape may be unwound from a roll.

Furthermore, it is not necessary for a primer to be applied wet-chemically, thereby making it possible to avoid the risk of soiling of the primer, by fingerprints or dust or the like, for instance. As a further consequence, special protective measures and specific training for employees in the application of a primer by a wet-chemical method can be avoided.

A further advantage is that long open times are made possible. In contrast to the wet-chemical mode of application of a liquid primer, the actual bonding of two components can take place at a significantly later point in time. In the case of the wet-chemical variant, the short opening times would necessitate relatively quick commencement of the actual bonding process, since otherwise the attachment would be reduced. Because the primer layer is activatable, it is possible not to activate the primer tape until immediately before the application of adhesive on the component. Activation may be accomplished, for example, by induction, pressure, temperature exposure, or by UV irradiation. By virtue of the primer tape, therefore, a wide time interval can elapse between the actual application of adhesive on the component and the pretreatment using the adhesive tape.

According to one embodiment, the upper side and/or the lower side have been provided with a removable protective film. As a result, the primer tape can be kept protected from external exposures and prepared in accordance with the utility by removal of the protective films. For example, the primer tape is first bonded to the first component. The upper side of the primer tape, not yet used, is protected by the further protective film until shortly before application with the adhesive, thereby contributing to the aforementioned particularly long open time.

According to one configuration, the primer layer at least comprises a compound having at least one isocyanate group and a compound having at least one hydroxyl group. The compound having the at least one hydroxyl group comprises, for example, a polyol, especially a diol or triol. In the case of a polyol, the compound is a polyhydric alcohol, more particularly a dihydric or trihydric alcohol.

According to one embodiment, the primer layer at least comprises the following components:
isocyanate,
polyhydric alcohol,
catalyst,
additive, and
filler.

The isocyanate is, for example, a polyisocyanate, for instance a compound having two or more isocyanate groups.

The aforesaid embodiments contribute to the above-stated advantages and functions.

According to one embodiment, the primer layer is embodied as a black primer layer. In other words, the black primer typically applied by a wet-chemical method is present as an adhesive layer.

The primer tape, especially the primer layer, comprises for example: polyol tri-, di, a solvent (water for example), additives (silica for example), isocyanate mixture (2,4; 4,4 MDI) and adhesion promoters (silane for example). The primer tape, especially the primer layer, comprises for example: isocyanate, polyhydric alcohol, a catalyst, an additive, and a filler.

According to a second aspect, the use of such an adhesive tape according to any of the above-described embodiments for bonding two components of a motor vehicle is disclosed.

As a result, the above-stated advantages and functions are made possible.

According to a further aspect, the assembly of two components of a motor vehicle is disclosed. Adhered to a first surface of the first component is a first adhesive tape according to the above-described embodiments. Adhered to a second surface of the second component, opposite the first surface, is a second adhesive tape according to one of the above-described embodiments. Disposed between the two adhesive tapes is an adhesive, so that after activation of the primer layers and chemical reaction of the adhesive tapes with the adhesive, a material bond is formed between the two components. The adhesive is, for example, a two-part polyurethane adhesive.

The assembly enables substantially the above-stated advantages and functions.

According to a further aspect, a method for bonding two components of a motor vehicle is described. The method comprises the steps of:
adhering a first adhesive tape according to one of the above-described embodiments by the lower side of the primer layer to a first surface of the first component;
adhering a second adhesive tape according to one of the above-described embodiments by the lower side of the primer layer to a second surface of the second component;
activating the primer layers of the two adhesive tapes,
applying an adhesive to the upper side of the activated primer layer of the first and/or second component,
assembling the two components one above the other, so that so that after chemical reaction of the adhesive with the primer layers of both components, a material bond is formed between the two components.

The method enables substantially the aforementioned advantages and functions. The primer layers are activated alternatively also after the application of the adhesive or else after the assembling of both components.

According to a further embodiment, the adhesive tapes of both components are taken off as lengths and/or unwound from a roll, before the steps of adhering.

Further advantages and functions are disclosed in the description below of an exemplary embodiment.

The exemplary embodiment is described below with reference to the appended figures. Across all of the figures, elements which are identical or have the same effect have been provided with the same reference symbols.

In the figures:

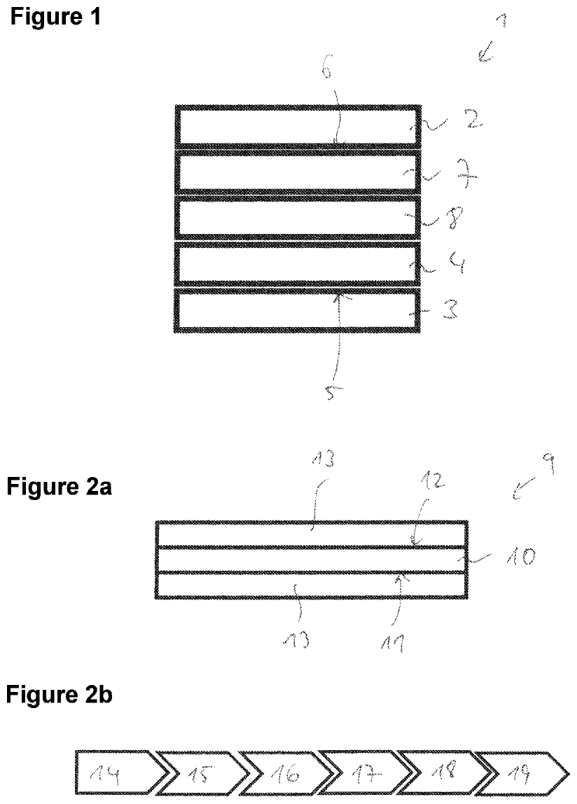

FIG. 1 shows a schematic view of a component assembly with surface pretreatment according to the prior art,

FIG. 2a shows a schematic view of an adhesive tape according to the exemplary embodiment of the invention,

FIG. 2b shows a schematic view of parts of the adhesive tape,

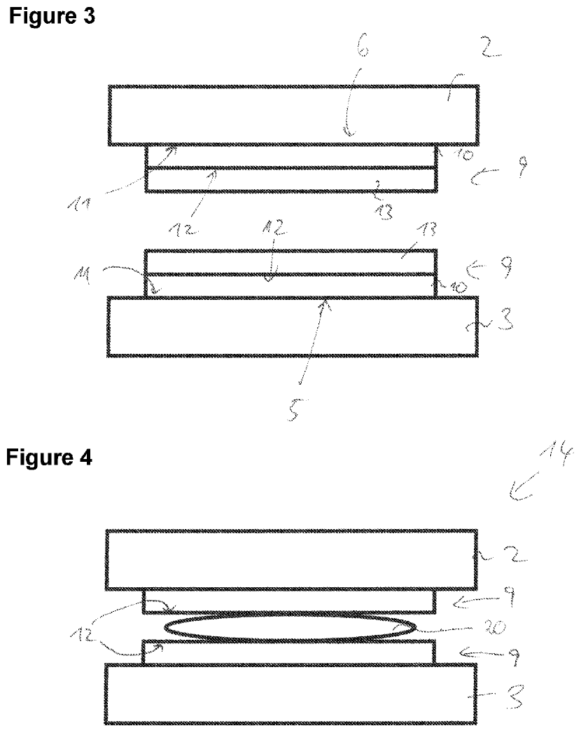

FIG. 3 shows a schematic view of two components with adhesive tapes as per FIGS. 2a and 2b,

FIG. 4 shows a component assembly with adhesive tapes as per FIGS. 2a and 2b, and

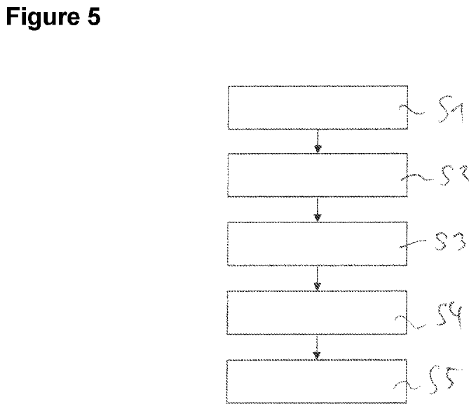

FIG. 5 shows a schematic flow diagram of a method for bonding two components of a motor vehicle.

FIG. 1 shows schematically a layerlike assembly 1 of two components 2 and 3, which are bonded to one another. The components 2 and 3 may also be referred to as substrates. The components 2 and 3 are parts from the vehicle sector, more particularly vehicle roof parts. For example, the first component 2 is a transparent roof element, for instance a sliding roof element, and the second component 3 is a metallic roof frame element. The first component 2 is fabricated, for example, of polycarbonate (PC), which may have additionally been coated, with a scratch-resistant and/or UV coating, for example. The second component 3 is, for example, a coated steel component. Other possible component materials are, for example, Xiran (SMA), ceramic frit, or glass. This, however, is not an exclusive list of materials.

To connect the two components 2 and 3 by means of bonding, the second component 3, for example, has been provided with a black primer 4 on a first surface 5. The opposite first component 2 is provided on an opposite second surface 6 with a primer 7, which may also be referred to as activator. For the ultimate joining of the two components 2 and 3, an adhesive 8, in the example of FIG. 1 a two-part polyurethane adhesive, is inserted in-between, so producing an attaching connection of the two components 2 and 3.

In the case of the variant described, the black primer 4 and/or the primer 7 have been applied wet-chemically. Between the components 2 and 3 and the respective bordering layers of the primer 7, of the adhesive 8, and of the black primer 4, boundary layers are formed, with no active chemical reaction taking place between the individual parts. A further disadvantage is that the black primer 8 gives off solvent vapors, which are or may be a health hazard to employees. Also it is necessary to provide for evaporation times. Moreover, an open time and a pot life are limited, since otherwise attachment of the adhesive 8 is reduced or impossible.

FIG. 2A describes an adhesive tape 9 according to one exemplary embodiment of the invention. The adhesive tape 9 comprises a primer layer 10, which is self-adhesive on a lower side 11 and an upper side 12 opposite the lower side 11. Both the upper side 12 and the lower side 11 have been provided with a removable protective film 13, which may be referred to as an inliner.

FIG. 2B shows exemplary parts of the primer layer 10, these being, for example, isocyanate 14, a diol 15, a triol 16, a catalyst 17, a filler 18, and additives 19.

The adhesive tape 9 constitutes essentially a double-sided adhesive tape, which comprises merely one primer or one primer material. The primer layer 10 has, for example, a mandated thickness of 5 to 20 μm. The adhesive tape 9 allows the above-stated advantages and functions, especially when applied for the bonding of two components from the vehicle sector.

The bonding of two components is described with reference to FIGS. 3 and 4 in conjunction with FIG. 5, which shows a schematic flow diagram of such a method.

In a first step S1, both the first component 2 and the second component 3 are provided on the opposing surfaces 5 and 6 with an adhesive tape 9 as per FIG. 2A.

In the first step S1, the protective film 13 of one of the lower sides 11 of the primer layer 10 is removed, and the adhesive tape 9 is adhered to the surfaces 5 and 6 respectively. It is then possible, almost independently of an open time, for the actual bonding of the components 2 and 3 to take place at a later step in the method.

In a following step S2, the two remaining protective films 13 are removed, so exposing the upper sides 12 of the primer layers 10.

In the next step S3, the two primer layers 10 of the adhesive tapes 9 are activated, by thermal energy input, for example.

In the next step S4, both or at least one upper side 12 of the respective primer layers 10 are provided with an adhesive 20. This is shown in FIG. 4, which represents a component assembly 14. The adhesive 20 is, for example, a two-part polyurethane adhesive. A one-part polyurethane adhesive is also possible.

In a further step S5, the components 2 and 3 are brought together in such a way that the adhesive 20 is present between the adhesive tapes 9, and, after chemical reaction with the activated primer layers 10, the two components 2 and 3 are materially bonded.

As a result of the activation of the primer layers, the isocyanate in particular is crosslinked and reacts additionally with the adhesive 20, so producing a particularly stable joining of the two components 2 and 3. In particular, an especially high level of crosslinking is achieved between the primer layers 10 and the adhesive 20. As a result, there is no formation, as described with reference to FIG. 1, of boundary layers between the primer layers 10 and the adhesive 20; instead, ultimately, all that there now is, respectively, a boundary layer between the components 2, 3 and the respective primer layer 10.

### LIST OF REFERENCE SYMBOLS

1 assembly
2 first component
3 second component
4 black primer
5 first surface
6 second surface
7 primer
8 adhesive
9 adhesive tape
10 primer layer
11 lower side
12 upper side
13 protective film
14 isocyanate
15 diol
16 triol
17 catalyst
18 filler
19 additive
20 adhesive

1. An adhesive tape for application to a component of a motor vehicle, consisting of:
a primer layer having a self-adhesive lower side and a self-adhesive upper side,
wherein the primer layer is designed such that it is activatable for chemical reaction with an adhesive.

2. The adhesive tape according to claim 1,
wherein the upper side and/or the lower side are provided with a removable protective film.

3. The adhesive tape according to claim 1,
wherein the primer layer at least comprises a compound having at least one isocyanate group and a compound having at least one hydroxyl group.

4. The adhesive tape according to claim 1,
wherein the primer layer at least comprises the following components:
isocyanate,
polyhydric alcohol,
catalyst,
additive, and
filler.

5. The adhesive tape according to claim 1,
wherein the primer layer is activatable thermally, mechanically, inductively or by means of UV input.

6. The adhesive tape according to claim 1,
wherein the primer layer is designed as a black primer layer.

7. The use of an adhesive tape according to claim 1 for bonding two components of a motor vehicle.

8. An assembly of two components of a motor vehicle, wherein:
adhered to a first surface of the first component is a first adhesive tape according to claim 1,
adhered to a second surface of the second component, opposite the first surface, is a second adhesive tape according to claim 1, and
disposed between the two adhesive tapes is an adhesive, so that after activation of the primer layers Q and chemical reaction of the adhesive tapes with the adhesive, a material bond is formed between both components.

9. A method for bonding two components of a motor vehicle, comprising the steps of:
adhering a first adhesive tape according to claim 1 by the lower side of the primer layer to a first surface (5) of the first component;
adhering a second adhesive tape according to claim 1 by the lower side of the primer layer to a second surface of the second component;
activating the primer layers (10) of the two adhesive tapes,
applying an adhesive to the upper side of the activated primer layer of the first and/or second adhesive tape,
assembling the two components one above the other, so that after chemical reaction of the adhesive with the primer layers of both components, a material bond is formed between the two components.

10. The method according to claim 9, wherein before the steps of adhering the adhesive tapes, the adhesive tapes are removed in lengths and/or unwound from a roll.
